(19) United States
(12) Patent Application Publication
(10) Pub. No.: US 2024/0308094 A1
(43) Pub. Date: Sep. 19, 2024

(54) Razor blade

(71) Applicant: DORCO CO., LTD., Yongin-si (KR)

(72) Inventors: Hyun Ju LEE, Seoul (KR); Seung Ki LEE, Seoul (KR)

(21) Appl. No.: 18/675,637

(22) Filed: May 28, 2024

Related U.S. Application Data
(63) Continuation of application No. PCT/KR2022/018950, filed on Nov. 28, 2022.

(30) Foreign Application Priority Data
Nov. 30, 2021 (KR) 10-2021-0169244

(51) Int. Cl. B26B 21/56

(52) U.S. Cl. CPC B26B 21/56

(57) ABSTRACT

A razor blade is proposed. The razor blade may include a substrate having a substrate edge with a substrate tip formed at an end portion. The substrate may include a first facet extending from the substrate tip to one side, a second facet extending from the substrate tip to the other side, a third facet extending from the first facet, and a fourth facet extending from the second facet. A slope of the first facet and a slope of the second facet may be different from each other. A first horizontal line perpendicular to the first vertical line may pass through a first point, and a second horizontal line perpendicular to the first vertical line may pass through a second point. A difference between a first vertical distance and a second vertical distance may be 10 micrometers to 30 micrometers.

### CROSS-REFERENCE TO RELATED APPLICATIONS

This is a continuation application of International Patent Application No. PCT/KR2022/018950 filed Nov. 28, 2022, which claims priority to Korean Patent Application No. 10-2021-0169244 filed on Nov. 30, 2021, the contents of each of which are incorporated by reference herein in their entirety.

### BACKGROUND

### Technical Field

The present disclosure relates to a razor blade, and more specifically, to a razor blade having an asymmetric shape.

### Description of Related Technology

A shaving experience perceived by a user feels when shaving can vary greatly depending on the shape of the razor blade. In particular, the shape of the razor blade's substrate greatly affects the cutting force of the razor blade.

### SUMMARY

One aspect is a razor blade with a lower cutting force and higher edge strength, compared to a current symmetrical substrate edge, by selectively thinning one of the facets.

Another aspect is a razor blade comprising: a substrate having a substrate edge with a substrate tip formed at an end portion, wherein the substrate includes: a first facet extending from the substrate tip to one side; a second facet extending from the substrate tip to the other side; a third facet extending from the first facet; and a fourth facet extending from the second facet, wherein a slope of the first facet and a slope of the second facet are different from each other with respect to a first vertical line that divides the substrate in two and passes through the substrate tip, wherein a first horizontal line perpendicular to the first vertical line passes through a first point where the first facet and the third facet meet, wherein a second horizontal line perpendicular to the first vertical line passes through a second point where the second facet and the fourth facet meet, and wherein a difference between a first vertical distance, which is a distance from the substrate tip to the first horizontal line, and a second vertical distance, which is a distance from the substrate tip to the second horizontal line, is 10 to 30 micrometers.

Another aspect is a razor blade comprising: a substrate having a substrate edge with a substrate tip formed at an end portion, wherein the substrate includes: a first facet extending from the substrate tip to one side; a second facet extending from the substrate tip to the other side; a third facet extending from the first facet; and a fourth facet extending from the second facet, and wherein a first horizontal line perpendicular to the first vertical line that bisects the substrate and passes through the substrate tip passes through a first point where the first facet and the third facet meet, a second horizontal line perpendicular to the first vertical line passes through a second point where the second facet and the fourth facet meet, a first vertical distance, which is a distance from the substrate tip to the first horizontal line, is 150 to 350 micrometers, a second vertical distance, which is a distance from the substrate tip to the second horizontal line, is 200 to 400 micrometers, and the second vertical distance is greater than the first vertical distance.

According to various embodiments, by selectively thinning one of the facets, there is an effect of providing a razor blade with a lower cutting force and higher edge strength compared to a conventional symmetrical substrate edge.

### BRIEF DESCRIPTION OF THE DRAWINGS

FIGS. 1 to 3 are schematic diagrams of a razor blade according to one embodiment of the present disclosure.

FIG. 4 is a schematic diagram showing an example of cutting hair using the razor blade according to one embodiment of the present disclosure.

FIG. 5 is a schematic diagram showing an example of cutting hair using a razor blade according to another embodiment of the present disclosure.

### DETAILED DESCRIPTION

In general, as the thickness of the substrate becomes thinner, the cutting force of the razor blade decreases further, and in this case, the user can feel a more comfortable shave experience. However, if the thickness of the substrate becomes thinner than a predetermined value, the durability of the razor blade may deteriorate. In other words, in designing the profile of a razor blade, there is a trade-off relationship between comfortable shaving experience and durability of the razor blade.

Current razor blades are generally configured so that two facets extending from the tip of the blade's substrate have symmetrical shapes. Therefore, in order to reduce the cutting force, the thickness of the substrate needs to be thin, but if the thickness of the substrate is too thin, durability is weakened and skin damage occurs, so there is a limit to thinning the thickness of the substrate.

Meanwhile, the process in which a razor blade cuts hair is divided into a cut-in process in which the tip of the razor blade comes into contact with the hair and the tip of the razor blade momentarily penetrates the hair, and a cutting process in which the razor blade cuts the hair and passes through it. Among these processes, the force required to cut hair is maximized during the cutting process.

Therefore, if the cutting resistance is lowered after a cut-in occurs due to the tip of the razor blade, the overall cutting force of the razor blade may be lowered.

Since the above razor blades are configured to perform shaving using a symmetrical substrate profile without considering this conception, there is a limit to lowering the cutting force of the razor blade as described above.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

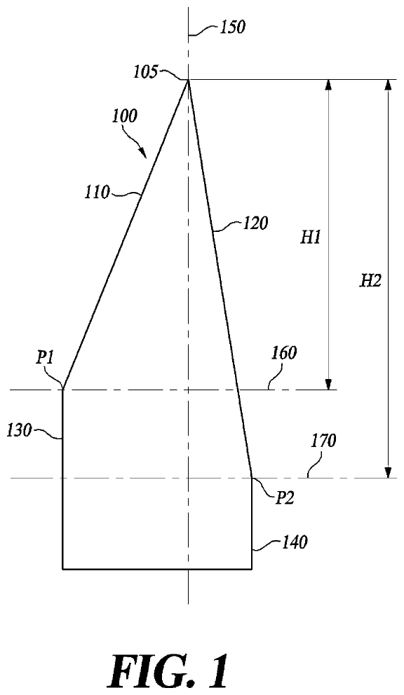

FIGS. 1 to 3 are schematic diagrams of a razor blade according to one embodiment of the present disclosure.

FIGS. 1 to 3, the razor blade according one embodiment of the present disclosure includes a substrate 100 having a substrate edge with a substrate tip 105 formed at an end portion.

The substrate 100 may include at least one of stainless steel, carbon steel, and ceramic. However, the present disclosure is not limited to the above, and the substrate 100 may include other materials.

Meanwhile, although not shown in the drawings, the razor blade according to one embodiment of the present disclosure may include a coating (not shown) laminated on the substrate 100.

In addition, the substrate 100 may include a first facet 110, a second facet 120, a third facet 130, and a fourth facet 140.

The first facet 110 extends from the substrate tip 105 to one side, and the second facet 120 extends from the substrate tip 105 to the other side. The third facet 130 extends from the first facet 110, and the fourth facet 140 extends from the second facet 120.

In this case, the point where the first facet 110 and the third facet 130 meet is defined as a first point P1, and the point where the second facet 120 and the fourth facet 140 meet is defined as a second point P2.

Meanwhile, an extension direction of the third facet 130 may be different from an extension direction of the first facet 110, and an extension direction of the fourth facet 140 may be different from an extension direction of the second facet 120. In this case, the extension direction of the third facet 130 and the extension direction of the fourth facet 140 may be substantially parallel, but are not necessarily limited thereto.

In addition, a slope of the first facet 110 and a slope of the second facet 120 may be different with respect to a first vertical line 150 that divides the substrate 100 into two and passes through the substrate tip 105. In this case, the slope of the first facet 110 may be greater than the slope of the second facet 120, but the present disclosure is not necessarily limited thereto.

Meanwhile, when shaving, the razor blade moves along a shaving direction while being somewhat laid down with respect to the skin surface. In this case, the cutting edge of the razor blade may be divided into a non-facing edge facing forward in the shaving direction and a facing edge facing backward in the shaving direction. At least a portion of the facing edge is in direct contact with the user's skin during shaving.

The razor blade according to one embodiment of the present disclosure is configured such that the first facet 110 and the second facet 120 have different slopes, so that the substrate 100 has an asymmetric shape with respect to the first vertical line 150. In this case, for example, when shaving, the first facet 110 and the third facet 130 may be non-facing edges, and the second facet 120 and the fourth facet 140 may be non-facing edges, the non-facing edge and the facing edge having asymmetrical shapes. This is the same even when the first facet 110 and the third facet 130 are facing edges, and the second facet 120 and the fourth facet 140 are non-facing edges.

Hereinafter, the shape of the substrate 100 required for more efficient shaving will be described in detail. In addition, a line perpendicular to the first vertical line 150 and passing through the first point PI is defined as a first horizontal line 160, and a line perpendicular to the first vertical line 150 and passing through the second point P2 is defined as a second horizontal line 170.

Meanwhile, the numerical range described below is only an example, and the present disclosure is not necessarily limited to the numerical range.

Referring to FIG. 1, the difference between a first vertical distance H1, which is the distance from the substrate tip 105 to the first horizontal line 160, and a second vertical distance H2, which is the distance from the substrate tip 105 to the second horizontal line 170, may be 10 to 30 micrometers. Therefore, the first horizontal line 160 and the second horizontal line 170 may not coincide with each other.

Accordingly, the thickness of the substrate 100 at a relative distance from the substrate tip 105 can be increased, and thus the durability of the substrate 100 can be increased.

In addition, the first vertical distance H1 may be 150 to 350 micrometers, and the second vertical distance H2 may be 150 to 400 micrometers. In this case, the second vertical distance H2 may be greater than the first vertical distance H1, but the present disclosure is not necessarily limited thereto.

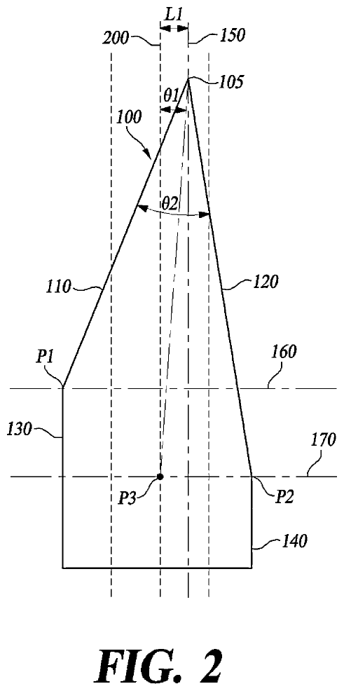

Referring to FIG. 2, the third facet 130 and the fourth facet 140 may be substantially parallel, and the second vertical line 200 may bisect the razor blade region between the third facet 130 and the fourth facet 140.

The substrate tip 105 may deviate from the second vertical line 200. In this case, a distance L1 of the substrate tip 105 from the second vertical line 200 in a direction perpendicular to the second vertical line 200 may be 1.7 to 20 micrometers.

In addition, when the point where the second horizontal line 170 meets the second vertical line 200 is defined as a central point P3, an angle θ1 formed by a straight line passing through the central point P3 and the substrate tip 105 and the second vertical line 200 may be 0.5 to 4 degrees.

Meanwhile, an angle θ2 formed by the first facet 110 and the second facet 120 may be 9.92 to 23 degrees.

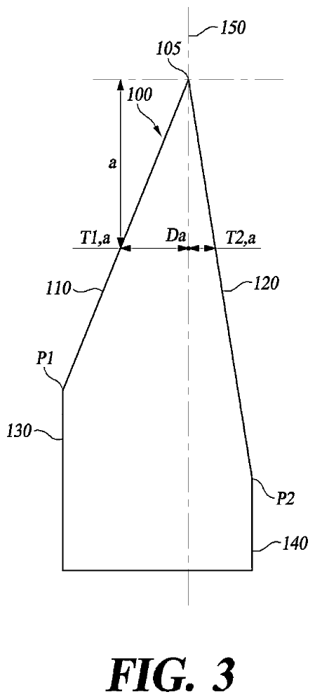

Referring to FIG. 3, the point “a” micrometer away from the substrate tip 105 in the direction of the first vertical line 150 is defined as Da, and the thickness of the first facet 110 with respect to the first vertical line 150 at Da is defined as T1,a, and the thickness of the second facet 120 at Da is defined as T2,a.

The ratio of the thickness T1,16 of the first facet 110 and the thickness T2,16 of the second facet 120 with respect to the first vertical line 150 at point D16 may be 1.05 to 2.72, preferably 1.4 to 1.7. That is, at point D16, the thickness of the first facet 110 may be thicker than the thickness of the second facet 120, but the present disclosure is not necessarily limited thereto.

Meanwhile, experimentally, when compared with a symmetrical razor blade having the same thickness on both sides with respect to a vertical line that bisects the substrate from the substrate tip at point D16, the razor blade of the present disclosure exhibits a reduction in cutting force of about 5% or more.

At point D60, the ratio of the thickness T1,60 of the first facet 110 and the thickness T2,60 of the second facet 120 with respect to the first vertical line 150 may be 1.05 to 2.13. That is, at point D60, the thickness of the first facet 110 may be thicker than the thickness of the second facet 120, but the present disclosure is not necessarily limited thereto.

In addition, the first facet 110 may be configured such that T1,10 has a value of 1.11 to 2.44 micrometers and T1,60 has a value of 6 to 15 micrometers. The second facet 120 may be configured such that T2,10 has a value of 1.11 to 2.44 micrometers and T2,60 has a value of 3.5 to 8 micrometers.

Meanwhile, when the thickness of the first facet 110 at Da with respect to the first vertical line 150 is defined as “T1,a” micrometer, “T1,a” may satisfy the following Equation 1.

$${T}_{1 , a} = m \times ( {a}^{n} ) \qquad ( Equation 1 )$$

$$( 0.3 \underline{<} m \underline{<} 0.7 , 0.6 \underline{<} n \underline{<} 0.99 , 10 \underline{<} a \underline{<} 60 )$$

In addition, when the thickness of the second facet 120 at Da with respect to the first vertical line 150 is defined as “T2,a” micrometer, T2,a may satisfy the following Equation 2.

$${T}_{2 , a} = m \times ( {a}^{n} ) \qquad ( Equation 2 )$$

$$( 0.2 \underline{<} m < 0.52 , 0.45 \underline{<} n \underline{<} 0.99 , 10 \underline{<} a \underline{<} 60 )$$

When the first facet 110 and the second facet 120 satisfy Equation 1 and Equation 2, respectively, the first facet 110 and the second facet 120 may have a curved shape. However, it is not necessary that the first facet 110 and the second facet 120 satisfy Equation 1 and Equation 2, respectively, and may be formed in the form of a straight line as shown in the drawings.

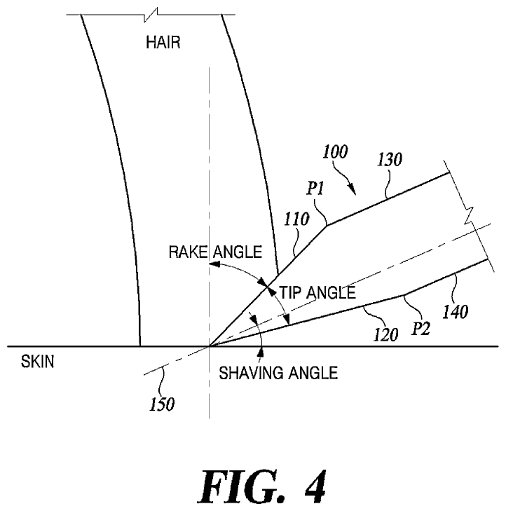

FIG. 4 is a schematic diagram showing an example of cutting hair using the razor blade according to one embodiment of the present disclosure.

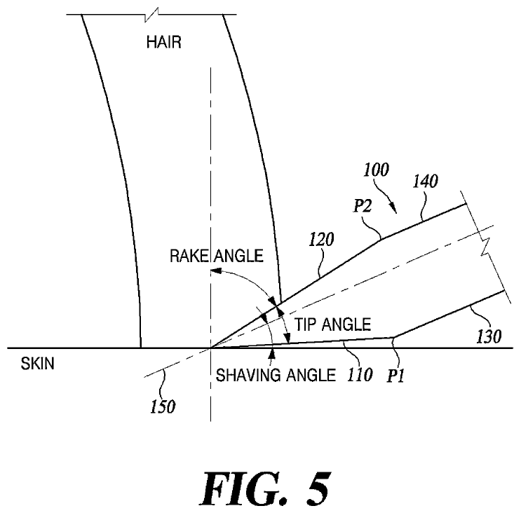

FIG. 5 is a schematic diagram showing an example of cutting hair using a razor blade according to another embodiment of the present disclosure.

Referring to FIGS. 4 and 5, the angle formed between the upper profile of the substrate 100 and a vertical line perpendicular to the skin surface may be a rake angle, and the angle formed by the first facet 110 and the second facet 120 may be a tip angle, and the angle formed between the first vertical line 150 and the skin surface may be a shaving angle.

FIG. 4 illustrates a razor blade in which the first facet 110 and the third facet 130 are non-facing edges, and the second facet 120 and the fourth facet 140 are facing edges. In this case, compared to a conventional razor blade of a symmetrical shape, the razor blade according to one embodiment of the present disclosure may be configured such that the thickness of the non-facing edge that is relatively far from the skin surface is thicker than the thickness of the facing edge that is relatively close to the skin surface.

Since the thickness of the facing edge of the razor blade according to one embodiment of the present disclosure is thinner, the thickness of the overall cutting edge can be thinned, and through this, cutting force can be reduced.

In addition, the razor blade according to one embodiment of the present disclosure can secure high durability by maintaining a thick thickness of the non-facing edge, and thus can provide a more suitable shave for people with thick hair.

Accordingly, the razor blade according to one embodiment of the present disclosure can reduce cutting force by thinning the thickness of the facing edge, and at the same time can maintain high durability by thickening the thickness of the non-facing edge.

FIG. 5 illustrates a razor blade in which the first facet 110 and the third facet 130 are facing edges, and the second facet 120 and the fourth facet 140 are non-facing edges. In this case, compared to the conventional razor blade of a symmetrical shape, the razor blade according to another embodiment of the present disclosure may be configured such that the thickness of the non-facing edge that is relatively far from the skin surface is thinner than the thickness of the facing edge that is relatively close to the skin surface. In this case, it is assumed that the shaving angle in FIG. 5 and the shaving angle in FIG. 4 are the same.

Compared to the conventional symmetrical razor blade, the razor blade according to another embodiment of the present disclosure has a larger rake angle compared to the shaving angle when the shaving angle is the same, which makes it easier to cause the hair to crack, thereby reducing the cutting force required to cut the hair.

In addition, the razor blade according to another embodiment of the present disclosure may be advantageous in terms of skin safety because the facing edge close to the skin has a thicker thickness.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

REFERENCE NUMERALS 100: substrate, 105: substrate tip, 110: first facet, 120: second facet, 130: third facet, 140: fourth facet, 150: first vertical line, 160: first horizontal line, 170: second horizontal line, 200: second vertical line, P1: first point, P2: second point, P3: central point

### CROSS-REFERENCE TO RELATED APPLICATION

This patent application claims priority to Patent Application No. 10-2021-0169244, filed in Korea on Nov. 30, 2021, which is incorporated herein by reference in its entirety.

What is claimed is:

1. A razor blade comprising:
a substrate comprising a substrate edge with a substrate tip formed at an end portion,
wherein the substrate includes:
a first facet extending from the substrate tip to one side;
a second facet extending from the substrate tip to the other side;
a third facet extending from the first facet; and
a fourth facet extending from the second facet,
wherein a slope of the first facet and a slope of the second facet are different from each other with respect to a first vertical line that divides the substrate in two and passes through the substrate tip,
wherein a first horizontal line perpendicular to the first vertical line passes through a first point where the first facet and the third facet meet,
wherein a second horizontal line perpendicular to the first vertical line passes through a second point where the second facet and the fourth facet meet, and
wherein a difference between a first vertical distance, which is a distance from the substrate tip to the first horizontal line, and a second vertical distance, which is a distance from the substrate tip to the second horizontal line, is 10 micrometers to 30 micrometers.

2. The razor blade of claim 1, wherein the first vertical distance is 150 micrometers to 400 micrometers.

3. The razor blade of claim 1, wherein the second vertical distance is 200 micrometers to 400 micrometers.

4. The razor blade of claim 1, wherein the slope of the first facet is greater than the slope of the second facet.

5. The razor blade of claim 1, wherein an extension direction of the third facet is different from an extension direction of the first facet, and
wherein an extension direction of the fourth facet is different from an extension direction of the second facet.

6. The razor blade of claim 1, wherein the third facet and the fourth facet are parallel to each other, and
wherein the substrate tip deviates from a second vertical line bisecting a region between the third facet and the fourth facet.

7. The razor blade of claim 6, wherein the substrate tip is away 1.7 micrometers to 20 micrometers from the second vertical line in a direction perpendicular to the second vertical line.

8. The razor blade of claim 6, wherein when a point at which a horizontal line, passing through the second point and perpendicular to the second vertical line, meets the second vertical line is defined as a central point, an angle formed by the second vertical line and a straight line passing through the central point and the substrate tip is 0.5 degrees and 4 degrees.

9. The razor blade of claim 1, wherein an angle formed by the first facet and the second facet is 3.8 degrees to 14.2 degrees.

10. The razor blade of claim 1, wherein when a point “a” micrometer away from the substrate tip in a direction of the first vertical line is defined as Da, a thickness ratio of the first facet and the second facet at D16 is 1.1 to 2.72 with respect to the first vertical line.

11. The razor blade of claim 1, wherein when a point “a” micrometer away from the substrate tip in a direction of the first vertical line is defined as Da, a thickness ratio of the first facet and the second facet at D60 is 1.05 to 2.13 with respect to the first vertical line.

12. The razor blade of claim 1, wherein, at a point “a” micrometer away from the substrate tip in a direction of the first vertical line, when a thickness of the first facet with respect to the first vertical line is defined as T1,a micrometers, T1,10 has a value of 1.11 to 2.44, and T1,60 has a value of 6 to 15.

13. The razor blade of claim 1, wherein, at a point “a” micrometer away from the substrate tip in a direction of the first vertical line, when a thickness of the second facet with respect to the first vertical line is T2,a micrometers, T2,10 has a value of 1.11 to 2.44, and T2,60 has a value of 3.5 to 8.

14. A razor blade comprising:
a substrate comprising a substrate edge with a substrate tip formed at an end portion,
wherein the substrate includes:
a first facet extending from the substrate tip to one side;
a second facet extending from the substrate tip to the other side;
a third facet extending from the first facet; and
a fourth facet extending from the second facet, and
wherein a first horizontal line perpendicular to the first vertical line that bisects the substrate and passes through the substrate tip passes through a first point where the first facet and the third facet meet,
wherein a second horizontal line perpendicular to the first vertical line passes through a second point where the second facet and the fourth facet meet,
wherein a first vertical distance, which is a distance from the substrate tip to the first horizontal line, is 150 micrometers to 350 micrometers,
wherein a second vertical distance, which is a distance from the substrate tip to the second horizontal line, is 200 micrometers to 400 micrometers, and wherein the second vertical distance is greater than the first vertical distance.
